(19) United States
(12) Patent Application Publication
(10) Pub. No.: US 2025/0030485 A1
(43) Pub. Date: Jan. 23, 2025

(54) CONFIGURABLE DEMULTIPLEXING CIRCUITS FOR INTENSITY-BASED MULTIPLEXED OPTICAL COMMUNICATIONS

(71) Applicants: John Paul T. Hansen, Olympia, WA (US); Karl L. Hansen, Burien, WA (US)

(72) Inventors: John Paul T. Hansen, Olympia, WA (US); Karl L. Hansen, Burien, WA (US)

(21) Appl. No.: 18/774,765

(22) Filed: Jul. 16, 2024

Related U.S. Application Data
(60) Provisional application No. 63/513,988, filed on Jul. 17, 2023.

(51) Int. Cl. H04B 10/60; H04J 14/08

(52) U.S. Cl. CPC H04B 10/60; H04J 14/08

(57) ABSTRACT

Configurable demultiplexing circuits for intensity-based optical communications are designed to detect individual input optical signals that have been combined in an intensity-based multiplexed group of signals. An array of repeating cells is used to detect a specific signal source whose input signal has been multiplexed with the input signals of other signal sources based only on their respective intensity. Separate demultiplexing circuits are used to detect different input signals. The arrays of repeating cells, which include adjustable attenuators, optical detectors, and logical circuitry (XOR gates), can make simultaneous measurements of all demultiplexing ports and detect the presence of the input optical signals, ideally at gigabit speeds or higher.

### BACKGROUND

### Technical Field

The present disclosure pertains to optical communications, and in particular demultiplexing circuits for intensity-based multiplexed optical communications.

### BRIEF SUMMARY

When multiple signals of the same wavelength are present in a single multiplexed optical signal, transmitted over a cable or over-the-air beam, the multiple signals may still be de-multiplexed (demultiplexed) as long as each signal has a unique intensity, such that each combination of input signals has a unique input intensity. Attention in this regard is drawn to U.S. patent application Ser. No. 18/180,001, filed Mar. 7, 2023, and titled “Intensity-Based Optical Multiplexing Systems and Methods”.

For example, a user may assign each input signal in an optical network their own intensity value such that each combination of the input signals, when multiplexed into a single multiplexed optical signal, yields a different total optical power reading for the multiplexed optical signal. In a four-input signal configuration, for example, signal 1 may have an intensity value=1 mW, signal 2 may have an intensity value=2 mW, signal 3 may have an intensity value=5 mW, and signal 4 may have an intensity value=9 mW.

In this configuration, each possible combination of the four input signals yields a different combined total optical power (mW) when the four signals are combined into the single multiplexed optical signal. In theory, by taking a single measurement of the combined total optical power of the multiplexed optical signal, it is possible to know which specific input signals are “on” (logical high value) or “off” (logical low value) at any given moment. This is accomplished using the configurable demultiplexing circuits for intensity-based optical communications (or opto-electronic intensity threshold filters) as described herein.

### BRIEF DESCRIPTION OF THE SEVERAL VIEWS OF THE DRAWINGS

FIG. 1A illustrates a signal communication environment in which two intensity-based optical signals are multiplexed for transmission and demultiplexed for further processing;

FIG. 1B illustrates a signal communication environment in which three intensity-based optical signals are multiplexed for transmission and demultiplexed for further processing;

FIG. 1C illustrates a signal communication environment in which four intensity-based optical signals are multiplexed for transmission and demultiplexed for further processing;

FIG. 2 is a schematic diagram depicting an optical signal detection unit for detecting an optical signal in accordance with the present disclosure;

FIG. 3 is a schematic diagram depicting a repeating cell for detecting an optical signal in accordance with the present disclosure;

FIG. 4 is a schematic diagram depicting an optical signal demultiplexing system comprised of repeating cells as shown in FIG. 3, for demultiplexing two input signals in a two-signal multiplexed optical communication;

FIG. 5 is a schematic diagram depicting an optical signal demultiplexing system comprised of repeating cells as shown in FIG. 3, for demultiplexing three input signals in a three-signal multiplexed optical communication;

FIG. 6 is a schematic diagram depicting an optical signal demultiplexing system comprised of repeating cells as shown in FIG. 3, for demultiplexing four input signals in a four-signal multiplexed optical communication;

FIG. 7 is a schematic diagram depicting an alternative consolidated optical signal demultiplexing system comprised of optical signal detection units as shown in FIG. 2, for demultiplexing two input signals in a two-signal multiplexed optical communication; and

FIG. 8 is a schematic block diagram depicting a digital intensity-based optical signal demultiplexing system constructed in accordance with the present disclosure, along with a flowchart illustrating functions performed by processing circuitry of the digital optical signal demultiplexing system.

FIG. 9 is an exemplary chart that introduces different sections of the tables shown in FIGS. 10-12D.

FIG. 10 is a table showing processing logic for an example of a one-beam system looking for an input light signal having a signal intensity value of 1.

FIG. 11A-11E are tables showing processing logic for an example of a two-beam system looking for an input light signal having a signal intensity value of 1 or 2.

FIG. 12A-12D are a set of tables showing processing logic for an example of a three-beam system, wherein the processing logic shown is looking for an input light signal having a signal intensity value of 1, while similar processing logic (not shown) looks for input light signals having a signal intensity value of 2 or 5.

### DETAILED DESCRIPTION

Configurable demultiplexing circuits for intensity-based optical communications (or opto-electronic intensity threshold filters), hereafter referred to as “deuxmux”, are designed to pull individual signals out of an intensity-based multiplexed group of input optical signals.

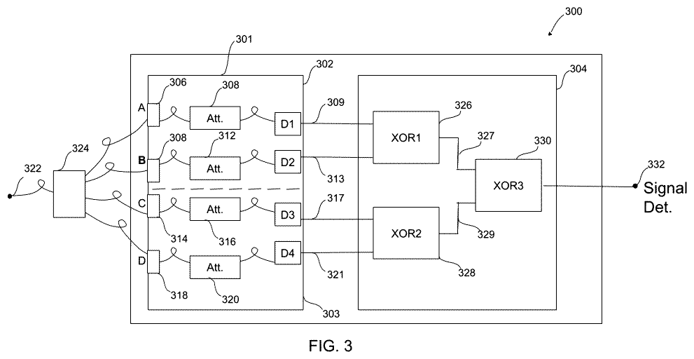

By way of introduction, in at least one embodiment (described in greater detail herein), an array of repeating cells of the kind shown in FIG. 3 is used to accurately detect a specific signal source whose input signal has been multiplexed with the input signals of other signal sources based only on their respective intensity. Separate demultiplexing circuits are used to detect different input signals. In some cases, a user may split a fiber transmission from a beam or a cable carrying the multiplexed optical signal into multiple parts, after which the arrays of repeating cells can make simultaneous measurements of all demultiplexing ports (e.g. A, B, C, D) at gigabit speeds (provided the response times of the XOR gates and detectors permit).

Briefly, in FIG. 3, a repeating cell 300 includes fiber cables that are spliced into adjustable attenuators 308, 312, 316, 320, detected by optical detectors D1, D2, D3, D4 (which may, in some embodiments include amplifiers such as transimpedance amplifiers (TIAs)), which deliver electrical signals into exclusive-OR (XOR) gates 326, 328. Each repeating cell 300 accommodates four inputs labeled A, B, C, D.

As illustrated in FIG. 3, each repeating cell 300 has four optical inputs optically coupled to four adjustable attenuators 308, 312, 316, 320. For any given signal, in some cases, the user may adjust the attenuators in a specific signal source's array of repeating cells such that only the specific optical intensity (mW) values that correspond to a signal from that specific signal source may produce usable logical “high” outputs. Any input optical intensity values that fall outside a given signal's calculated range will produce a logical “low” output.

In one or more embodiments, the attenuators 308, 312, 316, 320 are selectively configured to block an increasing amount of light, with A's attenuator blocking the least, B blocking more than A, C blocking more than B, and D blocking more than C. The amount of attenuation defining the detectable intensity ranges can be defined by the user by manually adjusting the attenuating components 308, 312, 316, 320. Each deuxmux array (or arrays of deuxmux circuits) detects the presence of one single signal based on its intensity in a network of several multiplexed signals. Users may “tune in” to each signal by selectively adjusting the attenuators 308, 312, 316, 320 present in each deuxmux array. For each input signal, there is a corresponding deuxmux array to filter out that signal from the others based on intensity only.

For example, consider a case in which the user knows that in a system with multiple input signal sources, where each signal source produces one signal, the optical intensity (brightness) levels (in mW) that correspond to an “on” state for a specific signal are slightly higher than the manually-set threshold for A and for B. Any optical power higher than A's set threshold will trigger a logical “high” from its respective detector D1, and any optical power less than B's set threshold will trigger a logical low from its respective detector D2. The combination of a high and a low logic signals from the detectors D1, D2 when both A and B are inputs of an XOR gate 326 in a logic section 304 will trigger a logical “high” from the XOR gate, otherwise the XOR gate will default to a “low” output state. Any optical power that is greater than B's set threshold will trigger a logical “high” from the detectors D1, D2 of both A and B and produce a low logical output from their XOR gate 326. For a given network, it is anticipated that a user will need a total number of repeating cells 300 equal to the minimum number of cells used to detect one signal times the total number of intensity-multiplexed input signals in the network.

A virtual network may take a single reading and know which signals in the multiplexed optical signal are “on” and which are “off” at a given instant in time.

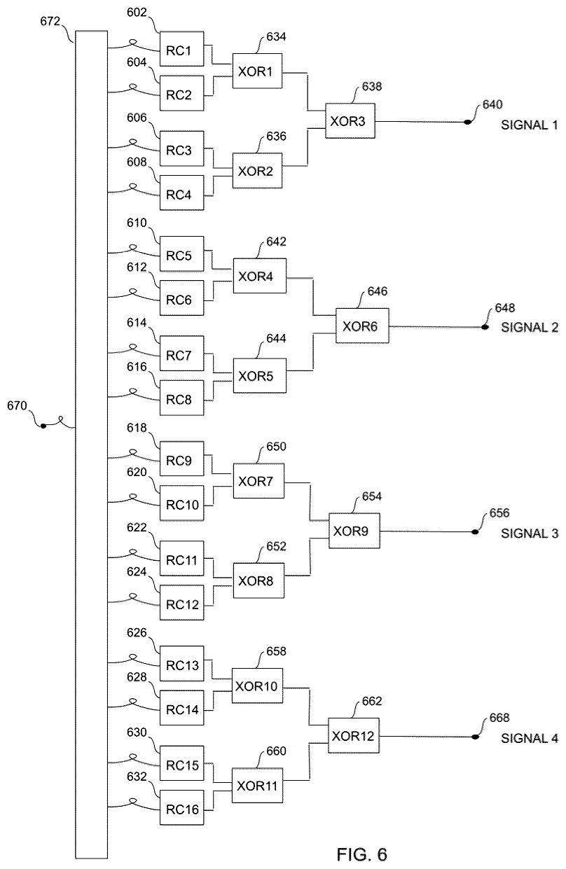

In some cases, such as when larger groups of multiplexed signal sources are input into a deuxmux circuit, a user may need to assign more optical “sums” (or “intensities”) that include the intensity of a given signal, for example as shown in FIG. 6. In the case of FIG. 6, the user may attach the fiber attenuation section to a “logic section” comprised of a narrowing series of XOR gates, e.g., as shown. If the number of attenuators is equal to n, then the total number of logic gates (XOR) required for a deuxmux system of this type is n-1.

Bitmasking is a process by which all possible combinations of inputs in a system, when assigned a number, have unique sums. This lets a user know the numerical constituents of any sum just by measuring it. The concept of combining multiple discrete signals and dealing with their sums can be applied optically. The process by which optical signals are organized (multiplexed and demultiplexed) throughout the deuxmux system is a form of optical “bitmasking.”

The optical bitmasking technique is similar in concept to computer digital bitmasking where for a four bit configuration (for example):
binary number 1111=8+4+2+1=15
binary number 1101=8+4+0+1=13
binary number 0011=0+0+2+1=3

Similarly, using optical intensity levels for a four-signal configuration:
beam 1111=1+2+5+9=17
beam 1101=1+2+0+9=12
beam 0011=0+0+5+9=14
beam 1000=1+0+0+0=1

All combinations of the input signals (having individual intensity levels of 1, 2, 5, and 9, respectively) sum to a unique combined intensity level when multiplexed into a single optical signal.

The amount of attenuation provided by an adjustable attenuator (e.g., attenuators 308, 312, 316, 320 in FIG. 3) is set corresponding to its role in a pair of attenuators, whose individual attenuation values are combined such that a narrow range of intensities of an input multiplexed signal successfully triggers a detector and, ultimately, a desired logical output signal from the respective deuxmux arrays. This may be compared, in some respects, to an optical bandpass filter system, which can be composed of one optical longpass filter and one optical shortpass filter whose blocking values do not overlap, leaving a narrow “band” through which light of a specific frequency (or a specific range of frequencies) may pass. This is also true of electronic filters.

### Example of Beams—Overview

Possible configurations appropriate for optical “bitmasking” as described herein. The zero-intensity state for an input signal is not shown, as it will always resolve to a “low” logical output, meaning no signal present or the input signal currently has a low (e.g., zero intensity) state.

In a deuxmux system's repeating cell 300, a portion of the light in an intensity-based multiplexed optical signal is processed through all four incoming ports A, B, C, D, and the respective individual adjustable attenuators 308, 312, 316, 320 are set in combination to detect specific desired optical intensities.

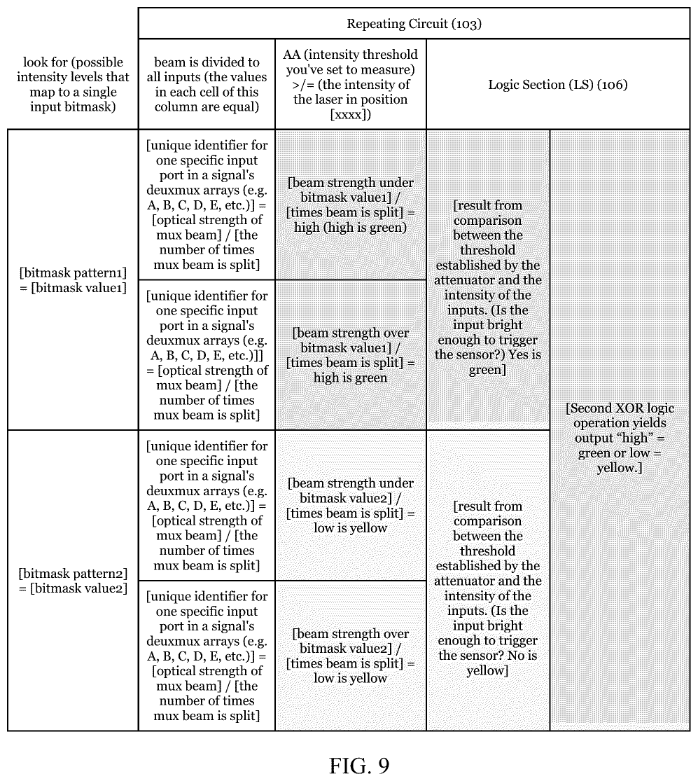

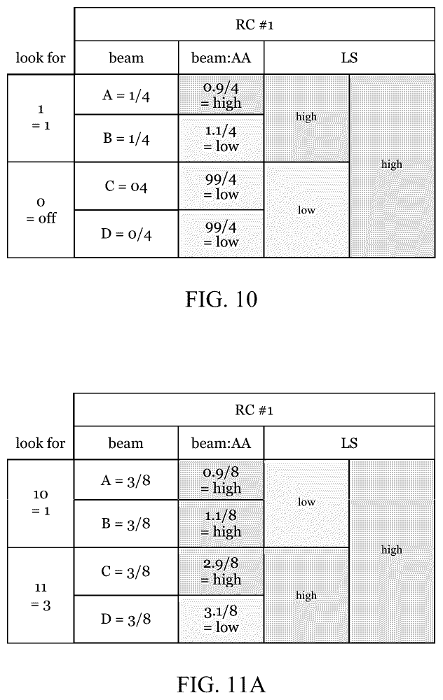

The chart in FIG. 9 introduces different sections of the tables that are shown in FIGS. 10-12D.

### Example of Beams—One Input Signal Configuration

The table in FIG. 10 is for a one-beam system looking for light signal intensity value 1. Other signal intensity combinations will produce results that are not guaranteed accurate.

Checking for signal 1 requires two ports of one four-port repeating cell (RC). For practical purposes, the incoming beam may be split into four portions, even though only two portions are used (e.g., with the A and B ports of the RC). The incoming beam has two different intensities, including zero. In each example herein, the tables show a system for extracting (demultiplexing) exactly one signal. A system that is configured to extract all signals present in an initially multiplexed beam would in some cases need to feature a greater number of repeating cells which may require splitting the incoming beam more times overall.

### Checking for Signal 1

Example 1: looking for intensity 1 (i.e., signal 1=1).

In this one signal input configuration in FIG. 10, the adjustable attenuators are set so that if the intensity of the incoming optical signal coupled to the A and B inputs is between 0.9 and 1.1 (divided by the number of time the incoming signal is split) then one detector of the attenuator pair (e.g., the A attenuator-detector) will produce a high output and the other detector of the attenuator pair (e.g., the B attenuator-detector) will produce a low output, causing the subsequent XOR logic to produce a high output. In other words, the attenuation provided by the pair of attenuators sets an intensity range (here 0.9-1.1) for detection when the input signal of interest (signal 1) is currently “on” (in a logical high state).

In this one signal input configuration, a weighted intensity value of 99 is used with the C and D attenuators to ensure that the corresponding logic always produces a low output. The incoming optical signal will not exceed an intensity of 99.

### Example of Beams—Two Input Signal Configuration

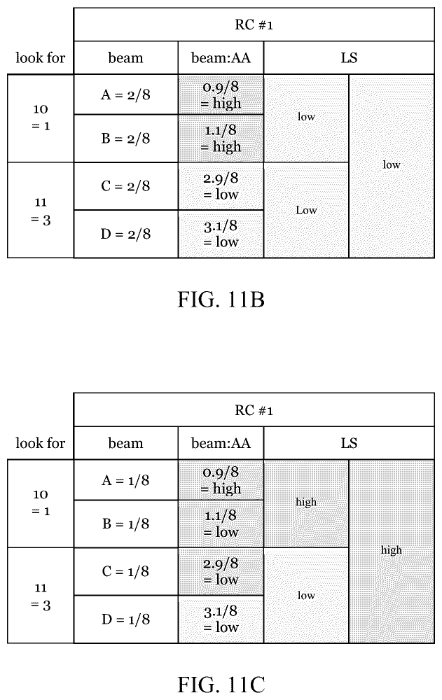

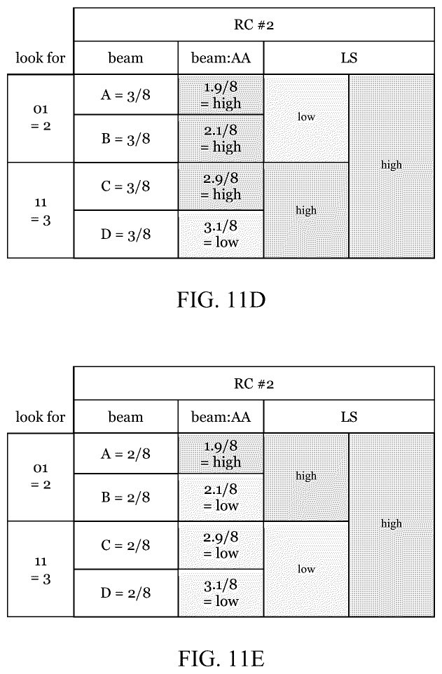

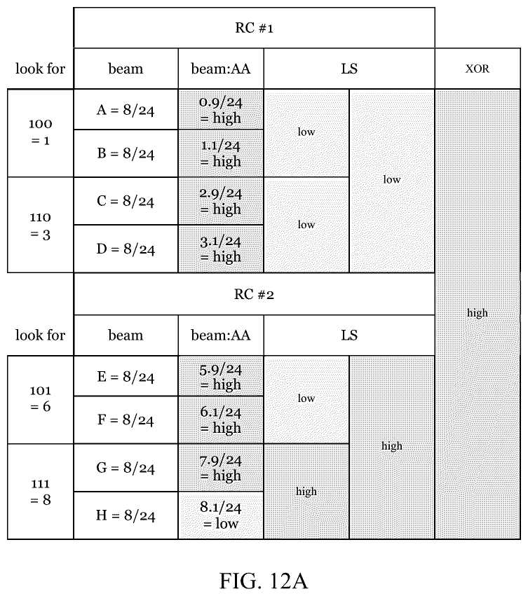

The tables in FIGS. 11A-11E are for a two-beam system looking for light signal intensity values 1 and 2. Other signal intensity combinations will produce results that are not guaranteed accurate.

Checking for each of the two signals requires four ports of one four-port RC. There are four different incoming multiplexed signal intensities (states) in this configuration, including zero—namely (1) both signals are off, (2) one of the two signals is on, (3) the other of the two signals is on, and (4) both signals are on. In each example, the tables in FIGS. 11A-11E each show a system for extracting exactly one signal. A system that is configured to extract all signals present in an initially multiplexed beam would in some cases need to feature a greater number of repeating cells which may require splitting the incoming beam more times overall.

The tables in FIGS. 11A-11E assume signal 1 of the two-beam system has an optical intensity of “1” when on, and signal 2 has an optical intensity of “2” when on. When signals 1 and 2 are combined into a multiplexed optical signal, signal 1 is on whenever the multiplexed signal has an optical intensity of “1” or “3”, and signal 2 is on whenever the multiplexed signal has an optical intensity of “2” or “3”. Thus, as can be seen, whenever the multiplexed signal has an optical intensity of “3”, both signals 1 and 2 are on at that given time.

### Checking for Input Signal 1 (Having Intensity Value 1)

Example 1: See FIG. 11A, configured to detect multiplexed intensity=3 (signals 11=1+2=3)

Example 2: See FIG. 11B. If the multiplexed intensity=2, signal 1 is not detected. This is a one-signal setup receiving a signal-two-only signal, which is not what RC #1 is looking for. The output of the logic section (LS) is low. Signals 01=0+2=2 is an example of when the incoming signal has an intensity that does not match the signal intensity that the RC looking for (in this case, RC #1 is looking for the presence of signal 1 having an intensity value of 1)

Example 3: See FIG. 11C, configured to detect multiplexed intensity=1 (signals 10=1+0=1)

### Checking for Signal 2 (Having Intensity Value 2)

Example 1: See FIG. 11D, configured to detect multiplexed intensity=3 (signals 11=1+2=3)

Example 2: See FIG. 11E, configured to detect multiplexed intensity=2 (signals 01=0+2=2)

### Example of Beams—Three Input Signal Configuration

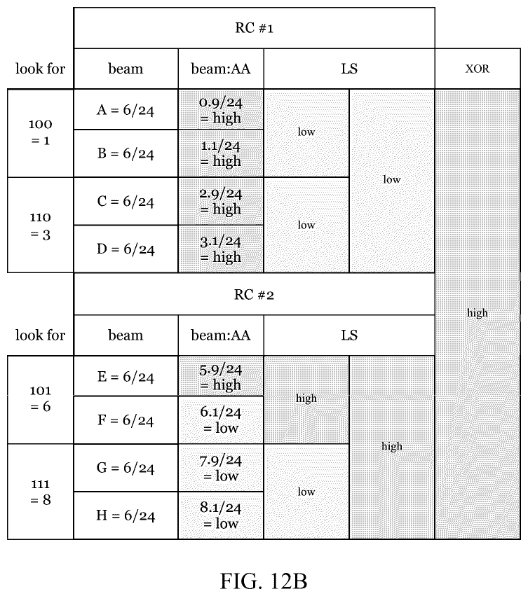

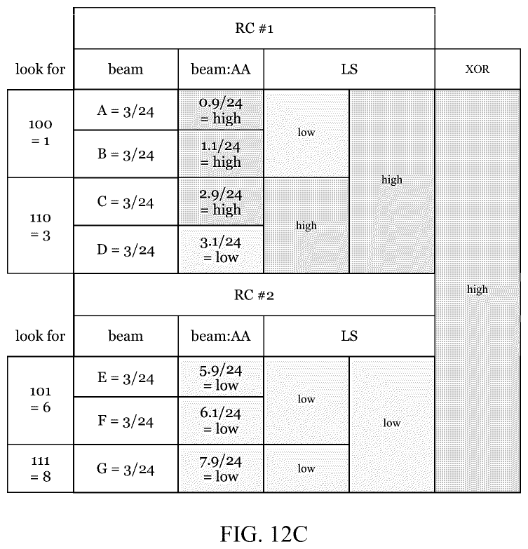

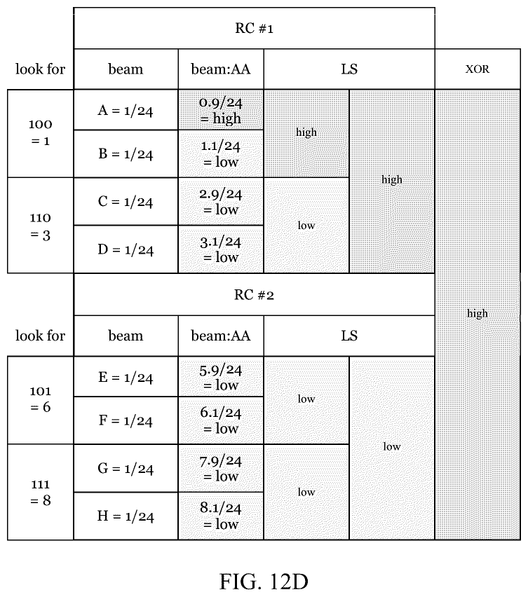

The tables in FIGS. 12A-12D are a first set of tables looking for signal 1 in a three-beam system. A three-beam system includes circuitry looking for light signal intensity values 1, 2, and 5. Other signal intensity combinations will produce results that are not guaranteed accurate.

Checking for each of the three signals requires eight ports across two four-port RCs. There are eight different incoming multiplexed signal intensity levels in this configuration, including zero. In each example, the following tables show a system for extracting exactly one signal. A system that is configured to extract all signals present in an initially multiplexed beam would in some cases need to feature a greater number of repeating cells which may require splitting the incoming beam more times overall.

The tables 12A-12D assume that signal 1 of the three-beam system has an optical intensity of “1” when on, that signal 2 has an optical intensity of “2” when on, and that signal 3 has an optical intensity of “5” when on.

When signals 1, 2, and 3 are combined into a multiplexed optical signal, signal 1 is on whenever the multiplexed signal has an optical intensity of “1”, “3”, “6”, or “8”; signal 2 is on whenever the multiplexed signal has an optical intensity of “2”, “3”, “7”, or “8”; and signal 3 is on whenever the multiplexed signal has an optical intensity of “5”, “6”, “7”, or “8”.

### Checking for Signal 1 (Having Intensity Value 1)

Example 1: See FIG. 12A, configured to detect multiplexed intensity=8 (signals 111=1+2+5=8).

Example 2: See FIG. 12B, configured to detect multiplexed intensity=6 (signals 101=1+0+5=6).

Example 3: See FIG. 12C, configured to detect multiplexed intensity=3 (signals 110=1+2+0=3).

Example 4: See FIG. 12D, configured to detect multiplexed intensity=1 (signals 100=1+0+0=1).

While not illustrated by specific tables, checking for signal 2 in a three-signal system is handled in a manner similar to checking for signal 1.

### Checking for Signal 2 (Having Intensity Value 2)

Example 1: The circuitry is configured to detect multiplexed intensity=8 (signals 111=1+2+5=8).

Example 2: The circuitry is configured to detect multiplexed intensity=7 (signals 011=0+2+5=7).

Example 3: The circuitry is configured to detect multiplexed intensity=3 (signals 110=1+2+0=3).

Example 4: The circuitry is configured to detect multiplexed intensity=2 (signals 010=0+2+0=2).

While not illustrated by specific tables, checking for signal 3 in a three-signal system is handled in a manner similar to checking for signals 1 and 2.

### Checking for Signal 3 (Having Intensity Value 5)

Example 1: The circuitry is configured to detect multiplexed intensity=8 (signals 111=1+2+5=8).

Example 2: The circuitry is configured to detect multiplexed intensity=7 (signals 011=0+2+5=7).

Example 3: The circuitry is configured to detect multiplexed intensity=6 (signals 101=1+0+5=6).

Example 4: The circuitry is configured to detect multiplexed intensity=5 (signals 001=0+0+5=5).

Example of Beams—Four Input Signal Configuration

A four-beam system looks for light signal intensity values 1, 2, 5, and 9. Other signal intensity combinations will produce results that are not guaranteed accurate.

Checking for each of the four signals requires 16 ports across four four-port RCs. There are 16 different incoming multiplexed signal intensity levels in this configuration, including zero. In each example, the following tables show a system for extracting exactly one signal. A system that is configured to extract all signals present in an initially multiplexed beam would in some cases need to feature a greater number of repeating cells which may require splitting the incoming beam more times overall.

By way of example, it may be assumed for the four-beam system that signal 1 has an optical intensity of “1” when on, that signal 2 has an optical intensity of “2” when on, that signal 3 has an optical intensity of “5” when on, and signal 4 has an optical intensity of “9” when on. When signals 1, 2, 3, and 4 are combined into a multiplexed optical signal, signal 1 is on whenever the multiplexed signal has an optical intensity of “1”, “3”, “6”, “8”, “10”, “12”, “15”, or “17”; signal 2 is on whenever the multiplexed signal has an optical intensity of “2”, “3”, “7”, “8”, “11”, “12”, “16”, or “17”; signal 3 is on whenever the multiplexed signal has an optical intensity of “5”, “6”, “7”, “8”, “14”, “15”, “16”, or “17”; and signal 4 is on whenever the multiplexed signal has an optical intensity of “9”, “9”, “11”, “12”, “14”, “15”, “16”, or “17”.

While not illustrated by specific tables, the following shows the processing logic to check for signal 1 (having intensity value 1).

Example 1: The circuitry is configured to detect multiplexed intensity=17 (signals 1111=1+2+5+9=17).

Example 2: The circuitry is configured to detect multiplexed intensity=15 (signals 1011=1+0+5+9=15).

Example 3: The circuitry is configured to detect multiplexed intensity=12 (signals 1101=1+2+0+9=12).

Example 4: The circuitry is configured to detect multiplexed intensity=10 (signals 1001=1+0+0+9=10).

Example 5: The circuitry is configured to detect multiplexed intensity=8 (signals 1110=1+2+5+0=8).

Example 6: The circuitry is configured to detect multiplexed intensity=6 (signals 1010=1+0+5+0=6).

Example 7: The circuitry is configured to detect multiplexed intensity=3 (signals 1100=1+2+0+0=3).

Example 8: The circuitry is configured to detect multiplexed intensity=1 (signals 1000=1+0+0+0=1).

While not specifically illustrated, the processing logic to check for signals 2, 3, and 4 in a four-signal system is similar to the processing logic checking for signal 1 except the circuitry looks for different optical intensity values as previously indicated for signals 2, 3, and 4.

Thus, using principles as introduced above, the present disclosure describes configurable optical circuits for demultiplexing intensity-based optical input signals that have been multiplexed for combined transmission over a common communication path (fiber optic cable or over-the-air light beam).

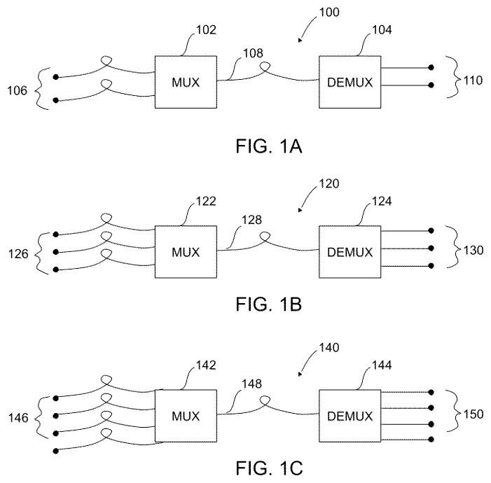

FIG. 1A illustrates a signal communication environment 100 in which two intensity-based optical signals are multiplexed for transmission and demultiplexed for further processing. The signal communication environment 100 includes an intensity-based optical multiplexer circuit 102 and an intensity-based optical demultiplexer circuit 104.

The intensity-based optical multiplexer circuit 102 may be constructed, e.g., in accordance with the disclosure in U.S. patent application Ser. No. 18/180,001, titled “Intensity-Based Optical Multiplexing Systems and Methods.” The intensity-based optical demultiplexer circuit 104 is described herein.

In the environment 100 as shown, two input signals 106 are combined by the multiplexer circuit 102 to form a multiplexed optical signal that is transmitted over a communication path 108. Once multiplexed, the two input signals 106 are each component input signals in the multiplexed optical signal that is transmitted over the communication path 108. The multiplexed optical signal is received by the optical demultiplexer circuit 104, which demultiplexes the two input signals 106 and outputs the two signals as signal outputs 110.

FIG. 1B illustrates a signal communication environment 120 in which three intensity-based optical signals are multiplexed for transmission and demultiplexed for further processing. Similar to the signal communication environment 100, the signal communication environment 120 includes an intensity-based optical multiplexer circuit 122 and an intensity-based optical demultiplexer circuit 124. The intensity-based optical multiplexer circuit 122 may be constructed, e.g., in accordance with the disclosure in U.S. patent application Ser. No. 18/180,001. In the environment 120 as shown, three input signals 126 are combined by the multiplexer circuit 122 to form a multiplexed optical signal that is transmitted over a communication path 128.

Once multiplexed, the three input signals 126 are each component input signals in the transmitted multiplexed optical signal. The multiplexed optical signal is received by the optical demultiplexer circuit 124, which demultiplexes the three input signals 126 and outputs the three signals as signal outputs 130. Similar configurations may be employed in signal communication environments in which four or more intensity-based optical signals are multiplexed for transmission and demultiplexed for further processing.

FIG. 1C, for example, illustrates a signal communication environment 140 in which four intensity-based optical signals are multiplexed and demultiplexed. In the environment 140 as shown, four input signals 146 are combined by a multiplexer circuit 142 to form a multiplexed optical signal that is transmitted over a communication path 148. Once multiplexed, the four input signals 146 are each component input signals in the transmitted multiplexed optical signal. The multiplexed optical signal is received by an optical demultiplexer circuit 144, which demultiplexes the four input signals 126 and outputs the four signals as signal outputs 150.

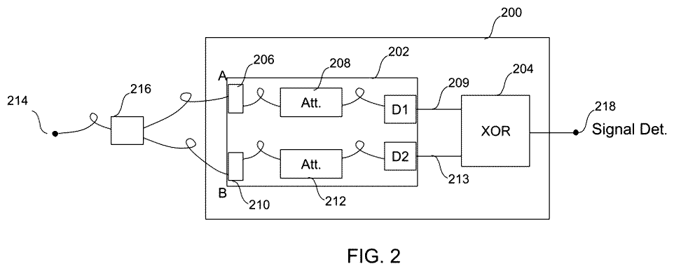

FIG. 2 is a schematic diagram depicting an optical signal detection unit 200 for detecting an optical signal in accordance with the present description. The circuitry shown in FIG. 2 and FIG. 3 illustrate building blocks usable for constructing optical circuits that can demultiplex any number of intensity-based optical signals which have been multiplexed for transmission, e.g., in accordance with the disclosure in U.S. patent application Ser. No. 18/180,001.

The optical signal detection unit 200 includes a detection section 202 and a logic section 204. The detection section 202 includes a first optical input 206 (labeled A) coupled to a first optical attenuator 208 that in turn is coupled to a first optical detector D1. The detection section 202 also includes a second optical input 210 (labeled B) coupled to a second optical attenuator 212 that in turn is coupled to a second optical detector D2.

The first and second optical attenuators 208, 212 are arranged in parallel and each receive a respective portion of an input optical signal 214 via the first and second optical inputs 206, 210. The first optical attenuator 208 is configured to attenuate its respective portion of the input optical signal 214 by a first amount of attenuation and produce a first attenuated output that is provided to the first optical detector D1. The second optical attenuator 210 is configured to attenuate its respective portion of the input optical signal 214 by a second amount of attenuation and produce a second attenuated output that is provided to the second optical detector D2. As will be understood from the present disclosure, the first amount of attenuation that is set for the first optical attenuator 208 is different than the second amount of attenuation that is set for the second optical attenuator 212.

The first and second optical detectors D1 and D2 are arranged in parallel to respectively receive the first and second attenuated outputs from the first and second optical attenuators 208, 212, and respectively produce first and second detector outputs 209, 213 that are provided to the logic section 204, which in this case is comprised of an exclusive-OR (XOR) gate.

In at least one implementation, as a default, the first and second detector outputs 209, 213 from the optical detectors D1 and D2 have a logic low state. The first detector output 209 from the first optical detector D1 has a logic high state when the first attenuated output from the first optical attenuator 208 has sufficient optical intensity to trigger the first optical detector D1.

Similarly, the second detector output 213 from the second optical detector D2 has a logic high state when the second attenuated output from the second optical attenuator 212 has sufficient optical intensity to trigger the second optical detector D2. In this manner, the first and second amounts of attenuation that are set for the first and second optical attenuators 208, 212 effectively defines a range of optical intensities for detecting when the input optical signal 214 has an optical intensity representing a logic high state.

As noted, the logic section 204 is comprised of an exclusive-OR (XOR) logic circuit arranged to perform an XOR operation on the first and second detector outputs 209, 213 and produce a signal detection output 218. The signal detection output 218 indicates a logic high state only when the first and second detector outputs 209, 213 have different logic states.

FIG. 2 further illustrates an optical splitter 216 that splits the input optical signal 214 into portions that are delivered to optical input A 206 and optical input B 210. The optical splitter 216 may be separate from, or integrated into, the optical signal detection unit 200. As illustrated, the optical splitter 216 is arranged to receive the input optical signal 214 and produce the respective portions of the input optical signal that are eventually received by the first and second optical attenuators 208, 212.

In at least one implementation of the present disclosure, the optical splitter 216 splits the input optical signal 214 into equal portions. In other words, the respective portions of the input optical signal 214 as received by the first and second optical attenuators 208, 212 are equal in optical intensity. In some implementations, the first and second amounts of attenuation that are set for the first and second optical attenuators 208, 212 are user adjustable. In this manner, the optical attenuators 208, 212 are configurable according to predefined thresholds to cause detection of when the input optical signal has an optical intensity in a predefined range.

In other implementations, the first and second amounts of attenuation for the first and second optical attenuators 208, 212 are set and are not user adjustable. To detect a logic high state of the input optical signal 214, the first and second amounts of attenuation are adjusted (by a user or other party, e.g., a system builder or configurator) according to an optical intensity of the input optical signal 214 known to represent a logic high state. For example, if the optical signal detection unit 200 is configured to determine whether the input optical signal 214 has an optical intensity of “1”, the first and second amounts of attenuation may be set such that optical D1 is triggered when the input optical signal 214 has an intensity above “0.9” and D2 is not triggered when the input optical signal 214 has an intensity that is not above “1.1”.

FIG. 3 is a schematic diagram depicting a repeating cell 300 configured to detect an optical signal in accordance with the present disclosure. As previously mentioned, and as will be further understood from the description that follows, the repeating cell 300 shown in FIG. 3 is a building block that is usable for constructing optical circuits for demultiplexing intensity-based input optical signals. Such optical circuits are able to demultiplex any number of intensity-based optical signals that have been multiplexed for transmission, e.g., in accordance with the disclosure in U.S. patent application Ser. No. 18/180,001.

The repeating cell 300 includes a detection section 301 and a logic section 304. The detection section 301 includes a first optical signal detection unit 302 and a second optical signal detection unit 303. As will be appreciated, the first optical signal detection unit 302 in combination with an XOR gate 326 (labeled XOR1) is similar in construction to the optical signal detection unit 200 shown in FIG. 2. Likewise, the second optical signal detection unit 303 in combination with an XOR gate 328 (labeled XOR2) is similar in construction to the optical signal detection unit 200 shown in FIG. 2.

The first optical signal detection unit 301 includes first and second optical inputs 306, 310 (labeled A, B) that are optically coupled to first and second optical attenuators 308, 312. The first and second optical attenuators 308, 312 are arranged in parallel and each receive a respective portion of an input optical signal 322. The first optical attenuator 308 is configured to attenuate its respective portion of the input optical signal 322 by a first amount of attenuation and produce a first attenuated output that is provided to a first optical detector D1. The second optical attenuator 312 is configured to attenuate its respective portion of the input optical signal 322 by a second amount of attenuation and produce a second attenuated output that is provided to a second optical detector D2. The first amount of attenuation that is set for the first optical attenuator 308 is different than the second amount of attenuation that is set for the second optical attenuator 312.

The first and second optical detectors D1 and D2 are arranged in parallel to respectively receive the first and second attenuated outputs from the first and second optical attenuators 308, 312 and respectively produce first and second detector outputs 309, 313. In at least one implementation, as a default, the first and second detector outputs 309, 313 represent a logic low state. The first detector output 309 represents a logic high state when the first attenuated output from the first optical attenuator 308 has sufficient optical intensity to trigger the first optical detector D1. Similarly, the second detector output 313 represents a logic high state when the second attenuated output from the second optical attenuator 312 has sufficient optical intensity to trigger the second optical detector D2. In this manner, the first and second amounts of attenuation that are set for the first and second optical attenuators 308, 312 effectively define a first range of optical intensities for detecting when the input optical signal 322 has an intensity indicating a component optical signal having a logic high state.

In a two-signal communication environment 100 as shown in FIG. 1A, the input optical signal includes two multiplexed intensity-based optical signals, each of which independently indicates a logic high or low state. In a three-signal communication environment 120 shown in FIG. 1B, the input optical signal includes three multiplexed intensity-based optical signals, each of which independently indicates a logic high or low state. Likewise, in a four-signal communication environment 140 as shown in FIG. 1C, the input optical signal includes four multiplexed intensity-based optical signals, each of which independently indicates a logic high or low state.

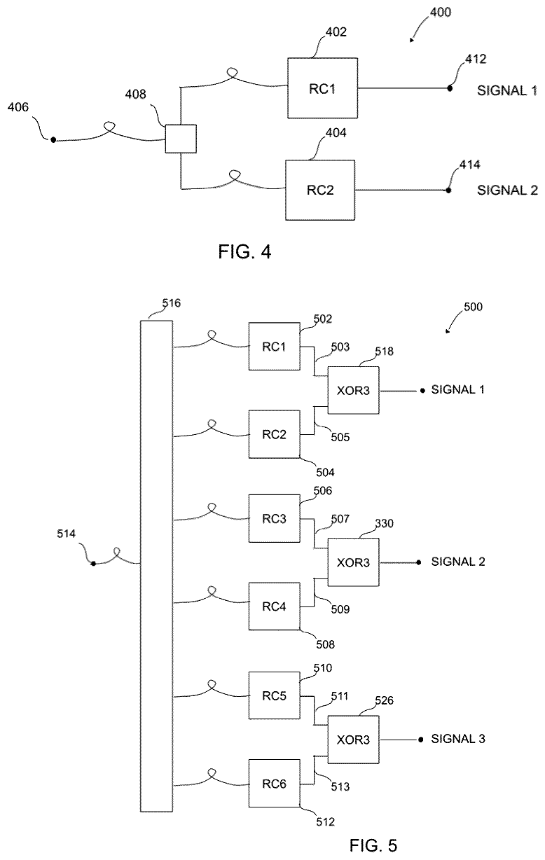

Further description of circuits for demultiplexing two-signal, three-signal, and four-signal configurations is provided with respect to FIGS. 4-6, respectively.

The logic section 304 of the repeating cell 300 includes a first exclusive-or (XOR) logic circuit 326 (labeled XOR1) arranged to perform an XOR operation on the first and second detector outputs 309, 313 to produce a first detection output 327. The first detection output 327 represents a logic high state only when the first and second detector outputs 309, 313 represent different logic states.

As previously noted, the detection section 301 also includes a second optical signal detection unit 303. The second optical signal detection unit 303 includes third and fourth optical attenuators 316, 320. The second optical signal detection unit 303 includes third and fourth optical inputs 314, 318 (labeled C, D) that are optically coupled to the third and fourth optical attenuators 316, 318.

The third and fourth optical attenuators 316, 320 are arranged in parallel and each receive a respective portion of the input optical signal 322. The third optical attenuator 316 is configured to attenuate its respective portion of the input optical signal 322 by a third amount of attenuation and produce a third attenuated output that is provided to a third optical detector D3. The fourth optical attenuator 320 is configured to attenuate its respective portion of the input optical signal 322 by a fourth amount of attenuation and produce a fourth attenuated output that is provided to a fourth optical detector D4. The third amount of attenuation that is set for the third optical attenuator 316 is different than the fourth amount of attenuation that is set for the fourth optical attenuator 320.

The third and fourth optical detectors D3 and D4 are arranged in parallel to respectively receive the third and fourth attenuated outputs from the third and fourth optical attenuators 316, 320 and respectively produce third and fourth detector outputs 317, 321. In at least one implementation, as a default, the third and fourth detector outputs 317, 321 represent a logic low state. The first detector output 317 represents a logic high state when the third attenuated output from the third optical attenuator 316 has sufficient optical intensity to trigger the third optical detector D3.

Likewise, the fourth detector output 321 represents a logic high state when the fourth attenuated output from the fourth optical attenuator 320 has sufficient optical intensity to trigger the fourth optical detector D4. In this manner, the third and fourth amounts of attenuation that are set for the third and fourth optical attenuators 316, 320 effectively define a second range of optical intensities for detecting when the input optical signal has a component optical intensity representing a logic high state. The second range of optical intensities effectively defined in the second optical signal detection unit 303 is different than the first range of optical intensities effectively defined in the first optical signal detection unit 302.

The logic section 304 includes a second exclusive-OR (XOR) logic circuit 328 (labeled XOR2) arranged to perform an XOR operation on the third and fourth detector outputs 317, 321 to produce a second detection output 329. The second detection output 329 represents a logic high state only when the third and fourth detector outputs 317, 321 represent different logic states.

The logic section 304 also includes a third exclusive-OR (XOR) logic circuit 330 (labeled XOR3) arranged to perform an XOR operation on the first and second detection outputs 327, 329 to produce a repeating cell detection output 332.

In some implementations, the first optical signal detection unit 302 is configured such that the first and second amounts of attenuation that are set for the first and second optical attenuators 308, 312 are user adjustable. In this manner, the optical attenuators 308, 312 are configurable according to predefined thresholds to enable detection of when the input optical signal 322 has an optical intensity in a first predefined range.

In some implementations, the second optical signal detection unit 303 is configured such that the third and fourth amounts of attenuation that are set for the third and fourth optical attenuators 316, 320 are user adjustable. In this manner, the optical attenuators 316, 320 are configurable according to predefined thresholds to enable detection of when the input optical signal 322 has an optical intensity in a second predefined range.

In some implementations, the first and second amounts of attenuation for the first and second optical attenuators 308, 312 are set and are not user adjustable. Similarly, in some implementations, the third and fourth amounts of attenuation for the third and fourth optical attenuators 316, 320 are set and are not user adjustable.

To detect a logic high state of a component input signal in the multiplexed input optical signal 322, the first and second amounts of attenuation are adjusted (by a user or other party, e.g., a system builder or configurator) according to an optical intensity of the component input signal known to represent a logic high state. Likewise, to detect a logic high state of the same or different component input signal in the multiplexed input optical signal 322, the third and fourth amounts of attenuation are adjusted (by a user or other party) according to an optical intensity of the same or different component input signal known to represent a logic high state.

The first and second amounts of attenuation for the first and second optical attenuators 308, 312 are adjusted such that, when the input optical signal 322 has a first intensity indicating a logic high state for a component input signal, one of the first or second attenuated outputs is within the first range of optical intensities, causing the first detection output 327 to indicate a logic high state.

The third and fourth amounts of attenuation for the third and fourth optical attenuators 316, 320 are adjusted such that, when the input optical signal 322 has a second intensity indicating a logic high state for a component input signal, one of the third or fourth attenuated outputs is within the second range of optical intensities, causing the second detection output 329 to indicate a logic high state. Ultimately, when one of the first detection output 327 or the second detection output 329 (but not both) indicates a logic high state, the XOR3 330 logic circuit produces a repeating cell output 332 that indicates a logic high state for the component input signal being detected.

Optical circuits constructed according to the present disclosure enable demultiplexing of two or more multiplexed intensity-based optical signals, e.g., as illustrated by the example schematic diagrams shown in FIGS. 4-6. As described in co-pending U.S. patent application Ser. No. 18/180,001, multiple optical signals may be multiplexed and demultiplexed using optical intensity alone when the optical intensity of each of the multiple optical signal is chosen so that any combination of the multiple optical signals (when “on” or in a “high” state) sums to a unique combined intensity in the multiplexed optical signal.

When multiple signals of the same wavelength are present in a single multiplexed optical signal, the multiple signals in the multiplexed optical signal may be demultiplexed as long as each signal has a unique intensity, such that each combination of the multiple signals has a unique input intensity. For example, in a four-input signal configuration, a first optical signal (“signal 1”) may have an intensity value of 1 mW, a second optical signal (“signal 2”) may have an intensity value of 2 mW, a third optical signal (“signal 3”) may have an intensity value of 5 mW, and a fourth optical signal (“signal 4”) may have an intensity value of 9 mW. With these intensity values, each possible combination of the four optical signals yields a different combined total optical intensity (mW) when any of the four optical signals are combined into the multiplexed optical signal.

By using the repeating cells (or opto-electronic intensity threshold filters) as shown in FIG. 3 for intensity-based optical communications, it is possible to know which specific input signals are “on” (logical high value) or “off” (logical low value) at any given moment. The specific amount of optical power in each input signal is not critical. What is important is that the amount of optical power in each input signal is assigned such that any combination of the input signals produces a unique combined optical power in the multiplexed signal. For purposes of illustration, input signals having an optical intensity of “1”, “2”, “5”, “9” and so on are discussed herein. These intensity values are relative intensity values (having a relative mW power) that, when added in any combination, sum to unique combined intensity values.

FIG. 4 is a schematic diagram depicting an optical signal demultiplexing system 400 comprised of repeating cells, arranged in parallel, for demultiplexing two input signals in a two-signal multiplexed optical communication, e.g., as shown in FIG. 1A. The optical signal demultiplexing system 400 includes two repeating cells 402, 404 as illustrated and described with respect to FIG. 3.

An input optical signal 406 is an intensity-based multiplexed optical signal that includes a combination of a first optical signal and a second optical signal, multiplexed as components of the multiplexed optical signal. The first optical signal has a first optical intensity when the first optical signal is in a logic high state, and the second optical signal has a second optical intensity when the second optical signal is in a logic high state. The second optical intensity is different than the first optical intensity.

The two repeating cells include a first repeating cell 402 and a second repeating cell 404. An optical splitter 408 is used to split the input optical signal 406 at least two ways and provides a respective portion of the input optical signal 406 to each of the repeating cells RC1 402 and RC2 404. Additionally, each repeating cell RC1 and RC2 includes an optical splitter (either a separate component or integrated therein, as described with respect to FIG. 3) that further splits the portion of the input optical signal four ways to provide a respective portion of the input optical signal 406 to the input ports A, B, C, D of the respective repeating cells RC1 and RC2.

In accordance with the processing performed by the repeating cell described in FIG. 3, the first repeating cell 404 in FIG. 4 produces a first repeating cell detection output 412 indicating a logic high state when the input optical signal 406 includes the first optical signal (as a multiplexed component) in a logic high state. Similarly, the second repeating cell 404 produces a second repeating cell detection output 414 indicating a logic high state when the input optical signal 406 includes the second optical signal (as a multiplexed component) in a logic high state.

The input optical signal 406 has four different signal intensities (representing different states) in this configuration. The input optical signal 406 has a first optical intensity of zero when both the first optical signal and the second optical signal are off (indicating logic low states). The input optical signal 406 has a second optical intensity when one of the first or second optical signals is on (indicating a logic high state for the optical signal). The input optical signal 406 has a third optical intensity the other of the first or second optical signals is on (indicating a logic high state for the optical signal). Lastly, the input optical signal 406 has a fourth optical intensity when both the first and second optical signals are on (indicating a logic high state for both optical signals).

By way of example, the first optical signal (also referred to herein “signal 1”) has an optical intensity of “1” when on, and signal 2 has an optical intensity of “2” when on. When signals 1 and 2 are combined into a multiplexed optical signal, signal 1 is recognized as being on whenever the multiplexed signal has an optical intensity of “1” or “3”, and signal 2 is recognized as being on whenever the multiplexed signal has an optical intensity of “2” or “3”. Thus, whenever the multiplexed optical signal has an optical intensity of “3”, both signals 1 and 2 are recognized as being on at that given time.

As described in the “Example of Beams—Two Input Signal Input Configuration” provided earlier in this disclosure, repeating cell RC1 402 in FIG. 4 is configured to determine whether the input optical signal 406 has an intensity value of 1 or 3. If so, RC1 402 produces a first repeating cell detection output 412 indicating that signal 1 is “on” at that time. Similarly, repeating cell RC2 404 in FIG. 4 is configured to determine whether the input optical signal 406 has an intensity value of 2 or 3. If so, RC2 404 produces a second repeating cell detection output 414 indicating that signal 2 is “on” at that time.

FIG. 5 is a schematic diagram depicting an optical signal demultiplexing system 500 comprised of repeating cells, arranged in parallel, for demultiplexing three input signals in a three-signal multiplexed optical communication, e.g., as shown in FIG. 1B. The optical signal demultiplexing system 500 includes six repeating cells 502, 504, 506, 508, 510, 512 as illustrated and described with respect to FIG. 3.

As with the input optical signal 406, an input optical signal 514 is an intensity-based multiplexed optical signal. In this case however, the input optical signal 514 includes a combination of first, second, and third optical signals (also referred to herein as signal 1, signal 2, and signal 3). The first optical signal (signal 1) has a first optical intensity when the first optical signal is in a logic high state, the second optical signal (signal 2) has a second optical intensity when the second optical signal is in a logic high state, and the third optical signal (signal 3) has a third optical intensity when the third optical signal is in a logic high state. The first, second, and third optical intensities are different such that any combination of the first, second, and third optical signals in the multiplexed input optical signal 514 has a unique combined optical intensity.

The six repeating cells in FIG. 5 includes a first repeating cell 502, a second repeating cell 504, a third repeating cell 506, a fourth repeating cell 508, a fifth repeating cell 510, and a sixth repeating cell 512 that are constructed and operate in accordance with the repeating cell shown and described in FIG. 3. The first through sixth repeating cells 502-512 respectively produce a first repeating cell detection output 503, a second repeating cell detection output 505, a third repeating cell detection output 507, a fourth repeating cell detection output 509, a fifth repeating cell detection output 511, and a sixth repeating cell detection output 513 in a manner as described by the repeating cell shown in FIG. 3.

The multiplexed input optical signal 514 has eight different signal intensities (representing different states) in this configuration. The input optical signal 514 has a first optical intensity of “0” when signals 1-3 are all off. The input optical signal 514 has a second optical intensity of “1” when signal 1 (alone) is on, a third optical intensity of “2” when signal 2 (alone) is on, a fourth optical intensity of “3” when signals 1 and 2 are on (signal 3 off), a fifth optical intensity of “5” when signal 3 (alone) is on, a sixth optical intensity of “6” when signals 1 and 3 are on (signal 2 off), a seventh optical intensity of “7” when signals 2 and 3 are on (signal 1 off), and an eighth optical intensity of “8” when signals 1-3 are all on.

The optical signal demultiplexing system 500 includes an optical splitter 516 that splits the input optical signal 514 at least six ways and provides a respective portion of the input optical signal 514 to each of the six repeating cells RC1-RC6. Additionally, each repeating cell RC1-RC3 includes an optical splitter (either separate from or integrated therein, as described with respect to FIG. 3) that further splits the portion of the input optical signal 514 four ways to provide a respective portion of the input optical signal to the input ports A, B, C, D of each respective repeating cell RC1-RC6.

As described in the “Example of Beams—Three Input Signal Configuration” provided earlier in this disclosure, repeating cell RC1 502 in FIG. 5 is configured to determine whether the input optical signal 514 has an intensity value of 1 or 3. If so, RC1 502 produces a first repeating cell detection output 503 indicating that signal 1 is “on” at that time.

Repeating cell RC2 504 is configured to determine whether the input optical signal 514 has an intensity value of 6 or 8. If so, RC2 504 produces a second repeating cell detection output 505 indicating that signal 1 is “on” at that time.

Similar processing is provided for signals 2 and 3. Repeating cell RC3 506 is configured to determine whether the input optical signal 514 has an intensity value of 2 or 3. If so, RC3 506 produces a third repeating cell detection output 507 indicating that signal 2 is “on” at that time.

Repeating cell RC4 508 is configured to determine whether the input optical signal 514 has an intensity value of 7 or 8. If so, RC4 508 produces a fourth repeating cell detection output 509 indicating that signal 2 is “on” at that time.

For signal 3, repeating cell RC5 510 is configured to determine whether the input optical signal 514 has an intensity value of 5 or 6. If so, RC5 510 produces a fifth repeating cell detection output 511 indicating that signal 3 is “on” at that time.

Repeating cell RC6 512 is configured to determine whether the input optical signal 514 has an intensity value of 7 or 8. If so, RC6 512 produces a sixth repeating cell detection output 513 indicating that signal 3 is “on” at that time.

In FIG. 5, the first and second repeating cell detection outputs 503, 505 are provided to a first additional XOR logic circuit 518 that produces an overall first signal detection output 520 indicating a logic high state when the input optical signal 514 includes the first optical signal (signal 1, as a multiplexed component) in a logic high state.

The third and fourth repeating cell detection outputs 507, 509 are provided to a second additional XOR logic circuit 518 that produces an overall second signal detection output 524 indicating a logic high state when the input optical signal 514 includes the second optical signal (signal 2, as a multiplexed component) in a logic high state.

Similarly, the fifth and sixth repeating cell detection outputs 511, 513 are provided to a third additional XOR logic circuit 526 that produces an overall third signal detection output 528 indicating a logic high state when the input optical signal 514 includes the third optical signal (signal 3, as a multiplexed component) in a logic high state. The optical circuit configurations and processing logic that enables the optical signal demultiplexing system 400 in FIG. 4 to demultiplex two input signals, and the optical signal demultiplexing system 500 in FIG. 5 to demultiplex three input signals, may be extended to demultiplex any number of intensity-based input signals that are combined into a multiplexed input optical signal for transmission.

By way of example, FIG. 6 provides a schematic diagram of such an extension of the systems shown in FIGS. 4 and 5, in this case depicting an optical signal demultiplexing system 600 for demultiplexing an input optical signal 670 comprised of four component input signals (otherwise referred to herein as signal 1, signal 2, signal 3, and signal 4).

The optical signal demultiplexing system 600 includes sixteen repeating cells RC1-RC16, arranged in parallel, for demultiplexing the four input signals in a four-signal multiplexed optical communication, e.g., as shown in FIG. 1C. The sixteen repeating cells include a first repeating cell 602, a second repeating cell 604, a third repeating cell 606, a fourth repeating cell 608, a fifth repeating cell 610, a sixth repeating cell 612, a seventh repeating cell 614, an eighth repeating cell 616, a ninth repeating cell 618, a tenth repeating cell 620, an eleventh repeating cell 622, a twelfth repeating cell 624, a thirteenth repeating cell 626, a fourteenth repeating cell 628, a fifteenth repeating cell 630, and a sixteenth repeating cell 632, each of which are constructed and operate as described with respect to the repeating cell shown in FIG. 3.

The input optical signal 670 is an intensity-based multiplexed optical signal that includes a combination of first, second, third, and fourth optical signals. The first optical signal has a first optical intensity (e.g., “1”) when the first optical signal is in a logic high state, the second optical signal has a second optical intensity (e.g., “2”) when the second optical signal is in a logic high state, the third optical signal has a third optical intensity (e.g., “5”) when the third optical signal is in a logic high state, and the fourth optical signal has a fourth optical intensity (e.g., “9”) when the fourth optical signal is in a logic high state. The first, second, third, and fourth optical intensities (e.g., intensities 1, 3, 5, and 9) are different such that any combination of the first, second, third, and fourth optical signals in the multiplexed input optical signal 670 has a unique combined optical intensity.

Each of the sixteen repeating cells 602-632 respectively produce first through sixteenth repeating cell detection outputs (not numbered here for brevity). The first and second repeating cell detection outputs are provided to a first additional XOR logic circuit 634, the third and fourth repeating cell detection outputs are provided to a second additional XOR logic circuit 636, and outputs of the first and second additional XOR logic circuits 634, 636 are provided to a third additional XOR logic circuit 638 that produces an overall first signal detection output 640 indicating a logic high state when the input optical signal 670 includes the first optical signal in a logic high state.

The fifth and sixth repeating cell detection outputs are provided to a fourth additional XOR logic circuit 642, the seventh and eighth repeating cell detection outputs are provided to a fifth additional XOR logic circuit 644, and outputs of the fourth and fifth additional XOR logic circuits 642, 644 are provided to a sixth additional XOR logic circuit 646 that produces an overall second signal detection output 648 indicating a logic high state when the input optical signal 670 includes the second optical signal in a logic high state.

The ninth and tenth repeating cell detection outputs are provided to a seventh additional XOR logic circuit 650, the eleventh and twelfth repeating cell detection outputs are provided to an eighth additional XOR logic circuit 652, and outputs of the seventh and eighth additional XOR logic circuits 650, 652 are provided to a ninth additional XOR logic circuit 654 that produces an overall third signal detection output 656 indicating a logic high state when the input optical signal 670 includes the third optical signal in a logic high state.

The thirteenth and fourteenth repeating cell detection outputs are provided to a tenth additional XOR logic circuit 658, the fifteenth and sixteenth repeating cell detection outputs are provided to an eleventh additional XOR logic circuit 660, and outputs of the tenth and eleventh additional XOR logic circuits 658, 660 are provided to a twelfth additional XOR logic circuit 662 that produces an overall fourth signal detection output 668 indicating a logic high state when the input optical signal 670 includes the fourth optical signal in a logic high state.

Further attention may be directed to the “Example of Beams—Four Input Signal Configuration” provided earlier in the present disclosure, which refers to aspects of the construction and processing provided by the repeating cells RC1-RC16 to determine whether the input optical signal 670 has an intensity value indicating that signal 1, signal 2, signal 3, and/or signal 4 is “on” at that time.

As the optical signal demultiplexing systems are further extended to produce demultiplexing systems that demultiplex five or more input optical signals, it is recognized that such extended systems simply include additional repeating cells as illustrated in FIG. 3, along with additional XOR logic circuits as described herein, to produce overall signal detection outputs indicating a logic high state when a particular component input optical signal is in a logic high state. More generally stated, the input optical signal is an intensity-based multiplexed optical signal that includes a combination of multiple optical signals, each optical signal of the multiple optical signals having an optical intensity when the respective optical signal is in a logic high state, wherein the optical intensity of each optical signal is different such that any combination of the multiple optical signals in the input optical signal has a unique combined optical intensity.

Also more generally stated, an optical signal demultiplexing system as described herein includes multiple repeating cells as illustrated and described in FIG. 3, wherein the multiple repeating cells each produce a respective repeating cell detection output. Each pair of the repeating cells provides their respective repeating cell detection outputs to an additional XOR logic circuit (e.g., as illustrated in FIGS. 5 and 6). As illustrated in FIG. 6, the outputs of each pair of additional XOR logic circuits are provided to yet another additional XOR logic circuit, until each component input optical signal of the multiple optical signals having a respective high logic state at that time is detected.

For the sake of simplicity and modular construction of the optical signal demultiplexing systems described herein, multiple repeating cells are employed, even when some of the repeating cells are configured to detect the same optical intensity of the multiplexed input signal. For example, as described with the two-input signal configuration in FIG. 4, a multiplexed input optical signal having an optical intensity of “3” results when both signal 1 and signal 2 of the two input signals are “on” and combined in the multiplexed input optical signal.

In FIG. 4, two separate repeating cells are employed, even though both repeating cells are configured to detect when the multiplexed input optical signal 406 has an optical intensity of “3”. In some implementations, it may be desirable to reduce the number of components in the optical signal demultiplexing system (saving operating power or space) while still employing the processing logic described herein and achieving the advantages of the solution provided by the present disclosure.

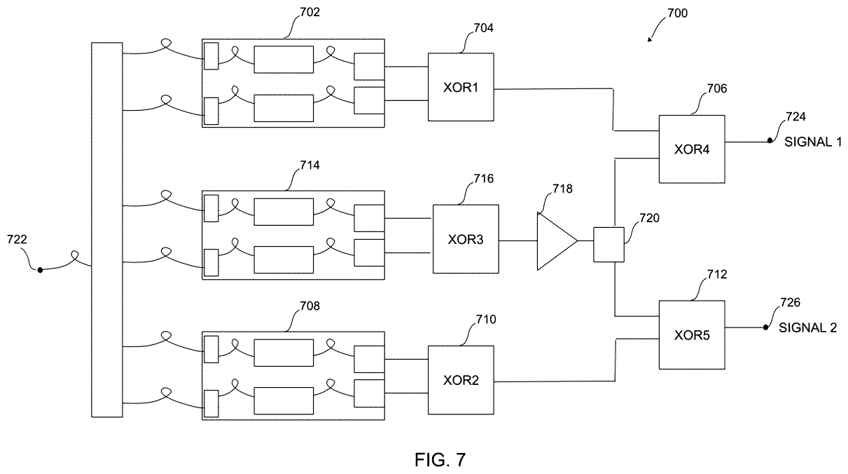

FIG. 7, for example, is a schematic diagram depicting an alternative consolidated optical signal demultiplexing system 700 in which three optical signal detection units as shown in FIG. 2 are employed, for demultiplexing two input signals (signal 1 and signal 2) in a two-signal multiplexed optical communication.

The consolidated optical signal demultiplexing system 700 includes a first optical signal detection unit 702 coupled to a first XOR logic circuit 704 (XOR1), a second optical signal detection unit 708 coupled to a second XOR logic circuit 710 (XOR2), and a third optical signal detection unit 714 coupled to a third XOR logic circuit 716 (XOR3). In a manner as described with respect to the optical signal detection unit in FIG. 2, the optical signal detection unit 702 in combination with XOR1 704 is configured to detect when the input optical signal 722 has an optical intensity of “1”, indicating that signal 1 is currently on while signal 2 is off. In a similar fashion, the optical signal detection unit 708 in combination with XOR2 710 is configured to detect when the input optical signal 722 has an optical intensity of “2”, indicating that signal 2 is currently on while signal 1 is off.

When both signal 1 and signal 2 are currently on and combined into the multiplexed input optical signal 722, the input optical signal 722 has an optical intensity of “3”. Rather than employ two different repeating cells to (redundantly) detect when the input optical signal 722 has an optical intensity of “3”, the optical signal demultiplexing system 700 in FIG. 7 employs a single (third) optical signal detection unit 714. The optical signal detection unit 714 in combination with XOR3 716 is configured to detect when the input optical signal 722 has an optical intensity of “3”. The output of the XOR logic circuit 716 in this system is optionally amplified by an amplifier 718 (e.g., by a standard electrical operational amplifier or other amplification device).

The output of the XOR logic circuit 716 (possibly amplified) is split by an optical splitter 720. The output of XOR1 704 and one of the outputs from the optical splitter 720 are provided to an additional XOR logic circuit 706 (XOR4) which produces an overall first signal detection output 724 indicating a logic high state when the input optical signal 722 includes the first optical signal (signal 1, as a multiplexed component) in a logic high state.

Similarly, the output of XOR2 710 and one of the outputs from the optical splitter 720 are provided to an additional XOR logic circuit 712 (XOR5) which produces an overall second signal detection output 726 indicating a logic high state when the input optical signal 722 includes the second optical signal (signal 2, as a multiplexed component) in a logic high state.

All of the foregoing disclosure illustrates and describes analog optical circuitry for constructing optical signal demultiplexing systems in accordance with the present disclosure. It should also be appreciated and understood that the optical signal multiplexing systems described herein may be implemented using digital circuitry to demultiplex a multiplexed intensity-based optical input signal and achieve advantages of the solution described herein.

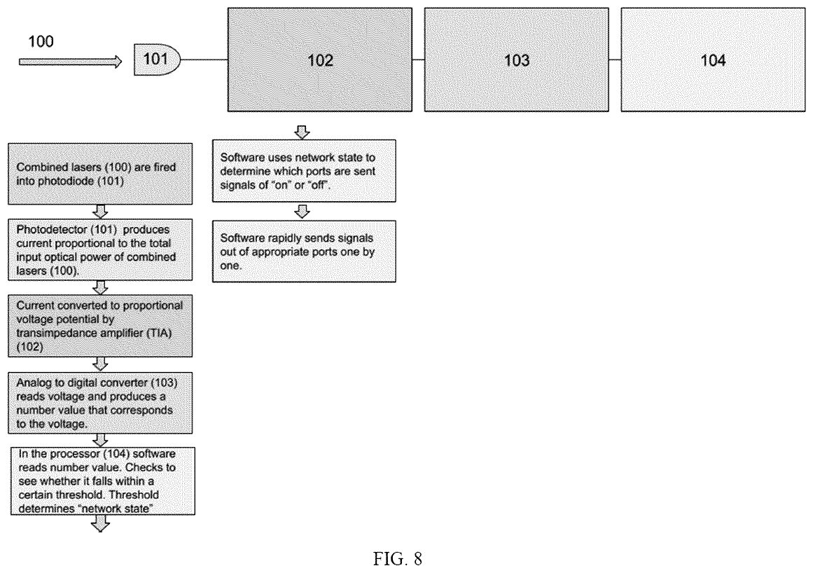

FIG. 8 includes an example schematic block diagram of a digital intensity-based optical signal demultiplexing system constructed in accordance with the present disclosure. Also included directly below is a flowchart illustrating functions performed by the processing circuitry of this example digital optical signal demultiplexing system.

The digital optical signal demultiplexing system above operates similar in concept to the analog optical signal demultiplexing systems described earlier herein, but the setting of thresholds and processing of signals is performed by executing software instructions rather than connecting hardware such as optical signal attenuators, optical detectors, and logic circuitry as described in FIGS. 1-7.

In FIG. 8, a multiplexed input optical signal 100 comprised of component input signals from multiple sources, such as lasers, is directed to an optical signal detector 101, such as a photodetector or photodiode (InGaAs, for example). The optical signal detector 101 produces an output electric signal (e.g., current signal) proportional to the optical intensity of the input light in the multiplexed input optical signal 100. In some cases, the photodiode may include or be connected to a receiver optical subassembly (ROSA), which may further improve its ability to process difficult-to-detect optical signals.

Second, a transimpedance amplifier (TIA) 102 converts the electric (current) signal into a voltage signal, which in most cases is amplified based on a value of the TIA's gain resistor. An analog-to-digital converter (ADC) 103 converts the analog voltage signal to a digital (numeric) value. In some implementations, an ADC 103 may be included as part of the digital processor 104 (e.g., a microprocessor or ASIC). In other implementations, the ADC 103 may be a separate component that is communicatively connected to the processor 104. The processor 104 executes software instructions that cause the processor 104 to read the ADC's digital output (number value) and determine whether the number value falls between certain thresholds established by a user or other system builder or configurator. These thresholds are akin to the amount of attenuation and detector thresholds in the analog systems described in FIGS. 1-7 that establish a range of optical signal intensity values that trigger detection.

In some cases, the thresholds evaluated by the processor 104 in a digital implementation may retrieved from a table stored in a memory accessible to the processor 104. If the number value representing detected signal intensity does not fall within a threshold-defined range, the software instructions cause the processor 104 to take no action. If the number value evaluated by the processor 104 falls within a threshold-defined range, the software instructions will cause the processor 104 to determine which threshold-defined range is satisfied by the number value, and take corresponding action(s) associated with that threshold-defined range, such as (by way of example only) “write a bit value of 1 to port1, write a bit value of 0 to port2, and write a bit value of 1 to port3” to, e.g., indicate detection of signal 1 and signal 3 in an “on” state, while signal 2 is in an “off” state, in a three input signal configuration.

The above processing is repeated for each given instance of time (e.g., bit period) that the multiplexed input optical signal may indicate a new optical intensity state for the multiplexed input optical signal.

Aspects of the various implementations and embodiments described above can be combined to provide yet further implementations and embodiments of the present disclosure. These and other changes can be made in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. An optical signal detection unit, comprising:
first and second optical attenuators arranged in parallel to each receive a respective portion of an input optical signal, wherein the first optical attenuator is configured to attenuate its respective portion of the input optical signal by a first amount of attenuation and produce a first attenuated output, and the second optical attenuator is configured to attenuate its respective portion of the input optical signal by a second amount of attenuation and produce a second attenuated output, wherein the first amount of attenuation is different than the second amount of attenuation;
first and second optical detectors arranged in parallel to respectively receive the first and second attenuated outputs and respectively produce first and second detector outputs, wherein by default the first and second detector outputs represent a logic low state, and wherein the first detector output represents a logic high state when the first attenuated output has sufficient optical intensity to trigger the first optical detector, and the second detector output represents a logic high state when the second attenuated output has sufficient optical intensity to trigger the second optical detector, the first and second amounts of attenuation effectively defining a range of optical intensities for detecting when the input optical signal has an optical intensity representing a logic high state; and
an exclusive-or (XOR) logic circuit arranged to perform an XOR operation on the first and second detector outputs to produce a detection output, the detection output indicating a logic high state only when the first and second detector outputs represent different logic states.

2. The optical signal detection unit of claim 1, further comprising an optical splitter arranged to receive the input optical signal and produce the respective portions of the input optical signal that are received by the first and second optical attenuators.

3. The optical signal detection unit of claim 2, wherein the respective portions of the input optical signal are equal in optical intensity.

4. The optical signal detection unit of claim 1, wherein the first and second amounts of attenuation are adjustable.

5. The optical signal detection unit of claim 4, wherein the first and second amounts of attenuation are adjusted according to an optical intensity of the input optical signal known to represent a logic high state.

6. A repeating cell comprising:
a first optical signal detection unit including:
first and second optical attenuators arranged in parallel to each receive a respective portion of an input optical signal, wherein the first optical attenuator is configured to attenuate its respective portion of the input optical signal by a first amount of attenuation and produce a first attenuated output, and the second optical attenuator is configured to attenuate its respective portion of the input optical signal by a second amount of attenuation and produce a second attenuated output, wherein the first amount of attenuation is different than the second amount of attenuation;
first and second optical detectors arranged in parallel to respectively receive the first and second attenuated outputs and respectively produce first and second detector outputs, wherein by default the first and second detector outputs represent a logic low state, and wherein the first detector output represents a logic high state when the first attenuated output has sufficient optical intensity to trigger the first optical detector, and the second detector output represents a logic high state when the second attenuated output has sufficient optical intensity to trigger the second optical detector, the first and second amounts of attenuation effectively defining a first range of optical intensities for detecting when the input optical signal has a component signal with an optical intensity representing a logic high state; and
a first exclusive-or (XOR) logic circuit arranged to perform an XOR operation on the first and second detector outputs to produce a first detection output, the first detection output representing a logic high state only when the first and second detector outputs represent different logic states;
a second optical signal detection unit including:
third and fourth optical attenuators arranged in parallel to each receive a respective portion of an input optical signal, wherein the third optical attenuator is configured to attenuate its respective portion of the input optical signal by a third amount of attenuation and produce a third attenuated output, and the fourth optical attenuator is configured to attenuate its respective portion of the input optical signal by a fourth amount of attenuation and produce a fourth attenuated output, wherein the third amount of attenuation is different than the fourth amount of attenuation;
third and fourth optical detectors arranged in parallel to respectively receive the third and fourth attenuated outputs and respectively produce third and fourth detector outputs, wherein by default the third and fourth detector outputs represent a logic low state, and wherein the first detector output represents a logic high state when the third attenuated output has sufficient optical intensity to trigger the third optical detector, and the fourth detector output represents a logic high state when the fourth attenuated output has sufficient optical intensity to trigger the fourth optical detector, the third and fourth amounts of attenuation effectively defining a second range of optical intensities for detecting when the input optical signal has a component signal with an optical intensity representing a logic high state, wherein the second range of optical intensities is different than the first range of optical intensities effectively defined in the first optical signal detection unit; and
a second exclusive-or (XOR) logic circuit arranged to perform an XOR operation on the third and fourth detector outputs to produce a second detection output, the second detection output representing a logic high state only when the third and fourth detector outputs represent different logic states; and
a third exclusive-or (XOR) logic circuit arranged to perform an XOR operation on the first and second detection outputs to produce a repeating cell detection output.

7. The repeating cell of claim 6, wherein:
the first optical signal detection unit is configured such that the first and second amounts of attenuation are adjustable; and
the second optical signal detection unit is configured such that the third and fourth amounts of attenuation are adjustable.

8. The repeating cell of claim 7, wherein:
the first and second amounts of attenuation are adjusted such that, when the input optical signal has a first intensity indicating a logic high state for a component input signal, one of the first or second attenuated outputs is within the first range of optical intensities, causing the first detection output to represent a logic high state; and
the third and fourth amounts of attenuation are adjusted such that, when the input optical signal has a second intensity indicating a logic high state for a component input signal, one of the third or fourth attenuated outputs is within the second range of optical intensities, causing the second detection output to represent a logic high state.

9. An optical signal demultiplexing system, comprising:
two repeating cells as defined in claim 6, wherein the input optical signal is an intensity-based multiplexed optical signal that includes a combination of a first optical signal and a second optical signal, the first optical signal having a first optical intensity when the first optical signal is in a logic high state, and the second optical signal having a second optical intensity when the second optical signal is in a logic high state, the second optical intensity being different than the first optical intensity; and
wherein:
the two repeating cells include:
a first repeating cell that produces a first repeating cell detection output indicating a logic high state when the input optical signal includes the first optical signal in a logic high state; and
a second repeating cell that produces a second repeating cell detection output indicating a logic high state when the input optical signal includes the second optical signal in a logic high state.

10. An optical signal demultiplexing system, comprising:
six repeating cells as defined in claim 6,
wherein the input optical signal is an intensity-based multiplexed optical signal that includes a combination of a first, second, and third optical signal, the first optical signal having a first optical intensity when the first optical signal is in a logic high state, the second optical signal having a second optical intensity when the second optical signal is in a logic high state, and the third optical signal having a third optical intensity when the third optical signal is in a logic high state, wherein the first, second, and third optical intensities are different such that any combination of the first, second, and third optical signals in the input optical signal has a unique combined optical intensity; and
wherein:
the six repeating cells are first, second, third, fourth, fifth, and sixth repeating cells that respectively produce first, second, third, fourth, fifth, and sixth repeating cell detection outputs;
the first and second repeating cell detection outputs are provided to a first additional XOR logic circuit that produces an overall first signal detection output indicating a logic high state when the input optical signal includes the first optical signal in a logic high state;
the third and fourth repeating cell detection outputs are provided to a second additional XOR logic circuit that produces an overall second signal detection output indicating a logic high state when the input optical signal includes the second optical signal in a logic high state; and
the fifth and sixth repeating cell detection outputs are provided to a third additional XOR logic circuit that produces an overall third signal detection output indicating a logic high state when the input optical signal includes the third optical signal in a logic high state.

11. An optical signal demultiplexing system, comprising:
sixteen repeating cells as defined in claim 6,
wherein the input optical signal is an intensity-based multiplexed optical signal that includes a combination of a first, second, third, and fourth optical signal, the first optical signal having a first optical intensity when the first optical signal is in a logic high state, the second optical signal having a second optical intensity when the second optical signal is in a logic high state, the third optical signal having a third optical intensity when the third optical signal is in a logic high state, and the fourth optical signal having a fourth optical intensity when the fourth optical signal is in a logic high state, wherein the first, second, third, and fourth optical intensities are different such that any combination of the first, second, third, and fourth optical signals in the input optical signal has a unique combined optical intensity; and
wherein:
the sixteen repeating cells are first through sixteenth repeating cells that respectively produce first through sixteenth repeating cell detection outputs;
the first and second repeating cell detection outputs are provided to a first additional XOR logic circuit, the third and fourth repeating cell detection outputs are provided to a second additional XOR logic circuit, and outputs of the first and second additional XOR logic circuits are provided to a third additional XOR logic circuit that produces an overall first signal detection output indicating a logic high state when the input optical signal includes the first optical signal in a logic high state;
the fifth and sixth repeating cell detection outputs are provided to a fourth additional XOR logic circuit, the seventh and eighth repeating cell detection outputs are provided to a fifth additional XOR logic circuit, and outputs of the fourth and fifth additional XOR logic circuits are provided to a sixth additional XOR logic circuit that produces an overall second signal detection output indicating a logic high state when the input optical signal includes the second optical signal in a logic high state;
the ninth and tenth repeating cell detection outputs are provided to a seventh additional XOR logic circuit, the eleventh and twelfth repeating cell detection outputs are provided to an eighth additional XOR logic circuit, and outputs of the seventh and eighth additional XOR logic circuits are provided to a ninth additional XOR logic circuit that produces an overall third signal detection output indicating a logic high state when the input optical signal includes the third optical signal in a logic high state; and
the thirteenth and fourteenth repeating cell detection outputs are provided to a tenth additional XOR logic circuit, the fifteenth and sixteenth repeating cell detection outputs are provided to an eleventh additional XOR logic circuit, and outputs of the tenth and eleventh additional XOR logic circuits are provided to a twelfth additional XOR logic circuit that produces an overall fourth signal detection output indicating a logic high state when the input optical signal includes the fourth optical signal in a logic high state.

12. An optical signal demultiplexing system, comprising:
multiple repeating cells as defined in claim 6,
wherein the input optical signal is an intensity-based multiplexed optical signal that includes a combination of multiple optical signals, each optical signal of the multiple optical signals having an optical intensity when the respective optical signal is in a logic high state, wherein the optical intensity of each optical signal is different such that any combination of the multiple optical signals in the input optical signal has a unique combined optical intensity;
wherein:
the multiple repeating cells each produce a respective repeating cell detection output;
each pair of the repeating cells provides their respective repeating cell detection outputs to an additional XOR logic circuit; and
outputs of each pair of the additional XOR logic circuits are provided to yet another additional XOR logic circuit, until each optical signal of the multiple optical signals in a respective high logic state is detected.
